(19) United States
(12) Patent Application Publication
(10) Pub. No.: US 2014/0295886 A1
(43) Pub. Date: Oct. 2, 2014

(54) GEOGRAPHICAL CONTENT ADDRESSING

(71) Applicants: Omesh Tickoo, Portland, OR (US); Ravishankar Iyer, Portland, OR (US); Rameshkumar Illikkal, Folsom, CA (US)

(72) Inventors: Omesh Tickoo, Portland, OR (US); Ravishankar Iyer, Portland, OR (US); Rameshkumar Illikkal, Folsom, CA (US)

(21) Appl. No.: 13/997,261

(22) PCT Filed: Mar. 15, 2013
(86) PCT No.: PCT/US2013/032250

§ 371 Date: Jun. 23, 2013

(51) Int. Cl. H04W 4/18

(52) U.S. Cl. CPC H04W 4/18; H04W 4/02
USPC 455/456.3

(57) ABSTRACT

Methods and apparatus relating to geographic content addressing are described. In an embodiment, a server (such as a content server or a content delivery server) transmits content to one or more devices at a first location based on location information corresponding to the first location of the one or more devices. The location information corresponding to the first location of the one or more devices is registered prior to transmission of the content to the one or more devices at the first location (e.g., at a registry server). Other embodiments are also claimed and described.

### FIELD

The present disclosure generally relates to the field of computing. More particularly, an embodiment of the invention generally relates to geographic content addressing.

### BACKGROUND

As computing devices becomes more common place, for example, through wide scale availability of mobile devices and data transmission services, users increasingly demand more ready and speedy access to a multitude of content.

Current technologies generally provide data transmissions from a source to specific devices for which data/information is targeted. This model enables the content delivery to selected devices without regard for placement or location of the physical target device. While the model is sufficient for conventional client-server like use situations, it introduces challenges in implementing a content-rich user experience.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates sample relative location based multi-screen multi-user collaboration components according to some embodiments.

FIG. 2 illustrates an embodiment of the components of a computing system, according to an embodiment.

FIGS. 3-4 illustrate flow diagrams of methods, according to some embodiments.

FIGS. 5 and 6 illustrate block diagrams of embodiments of computing systems, which may be utilized to implement some embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, current technologies generally provide data transmissions from a source to specific devices for which data/information is targeted. This model enables the content delivery to selected devices without regard for placement or location of the physical target device. While the model is sufficient for conventional client-server like use situations, it introduces challenges in implementing a content-rich user experience, e.g., based on multi-user collaboration and/or location based information/advertisement distribution.

To this end, some embodiments allow for geographic content addressing (instead of specific device addressing per Internet Protocol (IP) or Media Access Control (MAC) addresses, for example). In an embodiment, any device that occupies a given location can consume the content destined for that location. Some options for accomplishing this and various use cases include: (1) multi-user collaboration, e.g., where the displayed data can be sent to users through gestures that seamlessly integrate with the client device locations; (2) targeted advertisements for location dependent products and shopping experience; and/or (3) travel information for people travelling through certain geographical areas. Also, some embodiments associate contents/pixels to a location as opposed to a device making it possible to target information to multiple devices occupying a given geographical location. Hence, location based addressing, geographical pixel rendering, location aware display devices, protocols for transmission and information consumption based on location, etc. may be utilized in various embodiments.

Moreover, an embodiment introduces a mechanism for location based Global Data Addresses. For example, any global location on earth (and its elevation/atmosphere) can be addressed using a three-dimensional coordinate system such as a triplet of (latitude, longitude, altitude). The value of this triplet at a given location (which may be also referred to as (lat,long,alt) coordinate) can be associated with a given data transmission. In turn, any capable device that occupies given (lat,long,alt) coordinates will then consume the associated pixels/content. The technique can also be extended to include data transmissions addressed over a range of (e.g., three-dimensional) space.

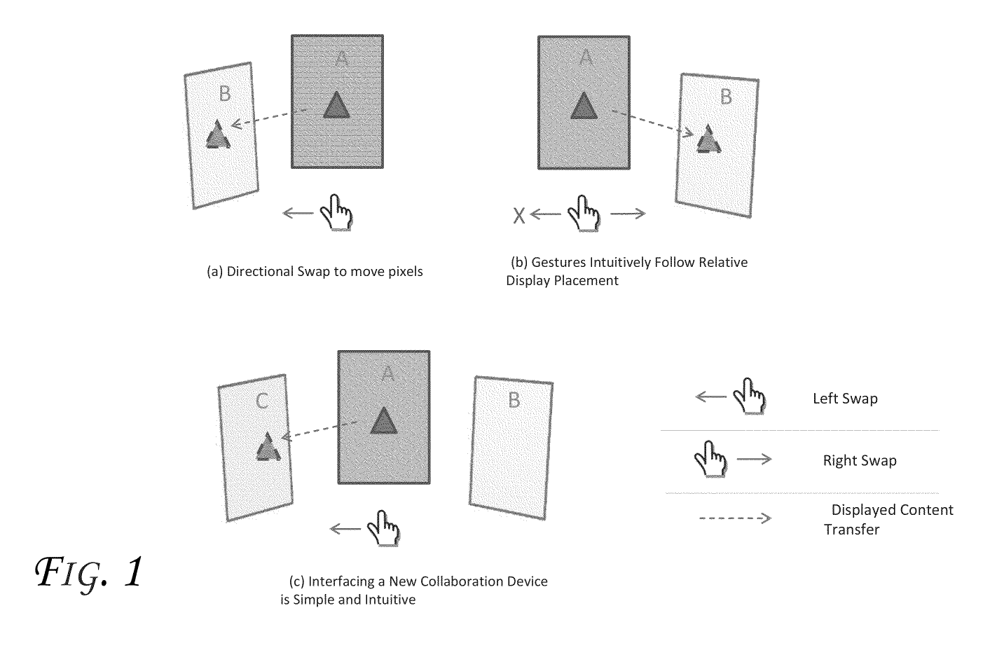

FIG. 1 illustrates sample relative location based multi-screen/multi-user collaboration components, according to some embodiments. As discussed herein, some embodiments may be used for various types of usage models including multi-screen/multi-user collaboration.

However, usage models are not limited to those specifically mentioned and may be extended to any usage model that would utilize content deliver to a location (e.g., per a three-dimensional coordinate system or triplet as discussed above).

In accordance with some embodiments, one or more of the following usage scenarios can be supported:
1) Multi-use/multi-screen collaboration: This use case enables users to collaborate interactively using multiple display surfaces. For example, as shown in FIG. 1, two users working on a project are using two different display surfaces placed side-by-side. Through an implementation of an embodiment, the images on Screens A and B are associated with the coordinates occupied by the display surfaces and not with the surfaces themselves. If the screens interchanged positions, the images would automatically interchange as well (e.g., as shown by portions (a) and (b) in FIG. 1). Using this property, many intuitive use cases can be implemented for collaboration. For example, user A manipulates data on his display surface and using a left slide like gesture “slides” data to user B's display surface (e.g., as shown by portion (a) of FIG. 1), who then can continue working on it. If the screen B is not placed on the right of screen A, the previously used left slide gesture will not work, for example. The infrastructure provided by some embodiments makes sure that the data is sent to the correct coordinate as defined by the gesture. So, the user A will have to slide the data right for display on Screen B (e.g., as illustrated by portion (b) of FIG. 1). If a new screen C were now to be positioned at the coordinated vacated by screen B (e.g., as shown in portion (c) of FIG. 1), any left gesture by user A will work to send the display data to Screen B.
2) Location Aware Information Broadcast: Various agencies/entities can use some embodiments for location aware information broadcasting. For example, when a mobile device roams into a region of interest to a particular entity/agency, the device can automatically receive the content related to that geographical location or area. The usages can vary from in-store/mall advertisements and offers to tourism, discount offers/coupons, personal safety (e.g., where an imminent danger is possible like flooding, hurricane, tornado, weather-related reports/warnings, traffic warnings/reports (such as accident warnings, etc. to allow a driver to safely slow down prior to reaching a marked site, e.g., which may be done intelligently by taking into account whether the driver is traveling in the direction of the marked site to avoid false warnings), law enforcement warnings (e.g., regarding potential operations in the surrounding area, persons of interest, active pursuits, etc.), road hazards, avalanche/rockslide warnings, etc.), and the like). In a campus and mall like setting, some embodiments provide for security, e.g., depending on the location, different messages can be sent to different users in case of emergencies. For example, a region of a campus could be asked to evacuate and the people in another region could be asked to lock their doors and stay put until further notifications depending on the location of a danger.

In case of tourism, the tourists can request and/or passively receive information about a location they are visiting by simply looking at their mobile smart display, while changing the location would lead to change in the received information.
3) Location Based In-flight/In-car Infotainment: For example, infotainment content may be displayed at a user's screen while flying that is catered to the location over which the aircraft is flying at any time. The infotainment content provision may be catered based on the remaining estimated travel time (e.g., only provide a list of shows that would complete during the remainder of the travel, which may be further adjusted by taking into account intervening events such as meal service, restroom breaks, etc.) The same or similar techniques may be applied to in-car infotainment.
4) Targeted traffic safety alerts. Depending on the location that a car is travelling through, a smart infotainment device can be provided that is capable of automatically receiving alerts, warnings and advisories issues pertinent to the region and/or direction of travel (e.g., at that instant or some time period that includes or is based on the current time). This method can replace the currently used radio based services that need human participation for tuning in to the relevant station. Also, while traveling in a car or other motor vehicle, a driver or occupant may receive various location based information, such as accident or traffic warnings/status/flow speed (e.g., in the direction of travel or otherwise potentially affecting the traffic flow in the direction of travel), etc.), gas/diesel prices (for local or upcoming stations in the direction of travel, for example, as compared with prices at locations within a threshold distance from a current location, where the threshold distance may be dynamically determined based on current and/or average gas mileage/kilometer values and/or remaining fuel reserve value), speed traps (e.g., where the warning may be dynamically adjusted/skipped based on comparison of current travel speed versus speed limit postings at the location), and the like.

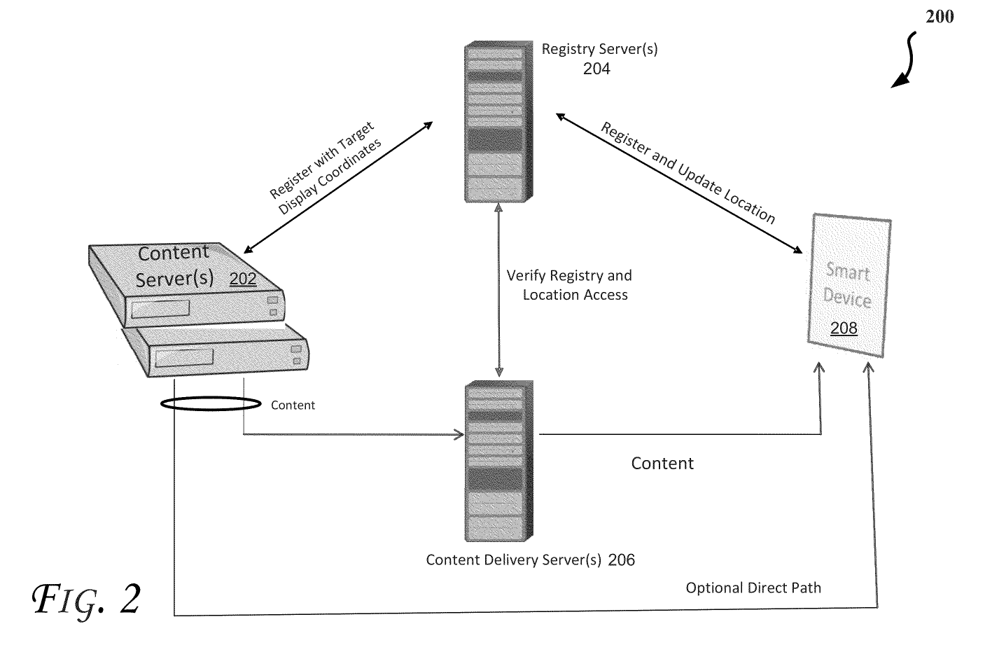

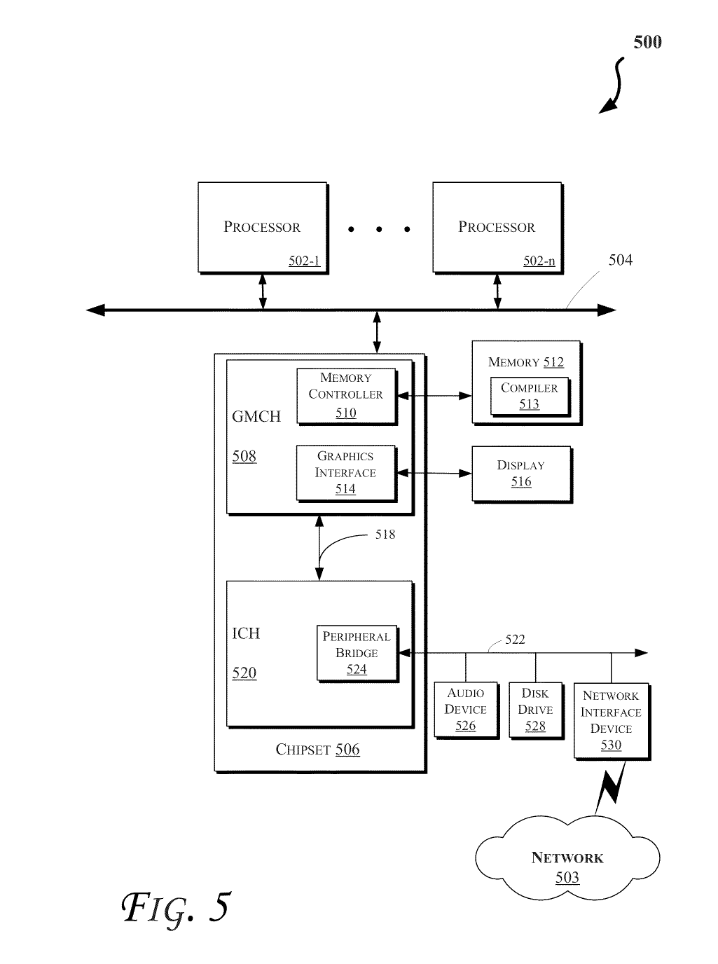

FIG. 2 illustrates an embodiment of the components of a computing system 200, according to an embodiment. As shown, system 200 includes one or more content servers 202 that chose to transmit content targeted for a given location. The server(s) 202 register with a centralized registry 204 (which may include one or more registry servers coupled to the content server(s) 202). The servers 204 keep track of location information/data/ranges and assigned data channels. In at least one embodiment, the components/devices/servers of system 200 communicate via dedicated lines (such as signal carrying wires) and/or one or more computer networks (such as those discussed with reference to FIG. 5).

Moreover, the centralized registry server(s) 204 may be used to register content for a given geographical region. A content engine/entity/application wishing to target content to a location (or range of locations) can request/claim the location through the centralized registry 204. Further, policies may be used for multiple content engines wishing to target the same location/ranges. The policies can include priority based exclusivity or window based display sharing for displayed data, for example.

System 200 also includes a centralized content delivery (e.g., which may be provided through one or more content delivery servers 206). In various embodiments, content can be routed to one or more end devices 208 (that may include mobile or smart devices such as phones, tablets, UMPC (Ultra-Mobile Personal Computer), laptop computers, ultrabooks, etc.) through one of:
a) Route through central delivery server (such as one or more servers 206): In this approach, the content engines send the content to a centralized engine such as server(s) 206 (where two or more of the servers 202/204/206 can be co-located in an embodiment). The central server (e.g., server(s) 206) then forwards the content to the appropriate devices 208 based on location data (and accessibility rules in an embodiment).
b) Direct transmission: In this approach, the centralized registry (e.g., server(s) 204) helps set up a connection between the content server 202 and chosen devices 208 after which the content is directly transmitted to the devices. One or more protocols as outlined below may be used to keep track of the device location in real time.

Generally, smart/mobile device(s) 208 may be capable of determining their physical location and communicating with the central registry/content delivery servers 204/206 to establish a connection and acquiring content for consumption. Furthermore, input transmission back to the content servers 206 may be based on protocol(s) defined for user input transmission back to the content servers 206. Such scenarios involve a user navigating the display on a device 208. Once the forward connection is established, an optional reverse route can be provided for interactive services including user input transmission.

Moreover, the location based content delivery may be performed without regard for customary security concerns in an embodiment, e.g., as long as the location information is reliable (e.g., not spoofed or otherwise modified by unauthorized entities). Also, location determination may be left to other entities (such as device(s) 208, which may be optionally verified by the registry server(s) 204 based on additional information received from entities other than the device 208 such as network switches, cellular towers, Internet service providers, etc. coupled between the device 208 and the server(s) 204), as long as the server knows the location information, the content may be sent to a specific location.

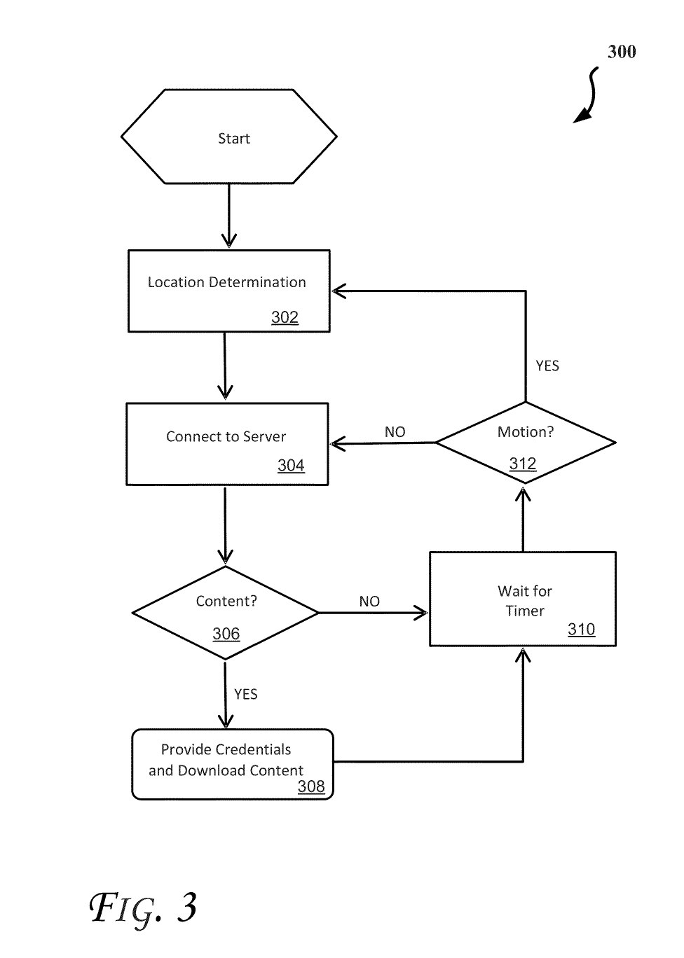

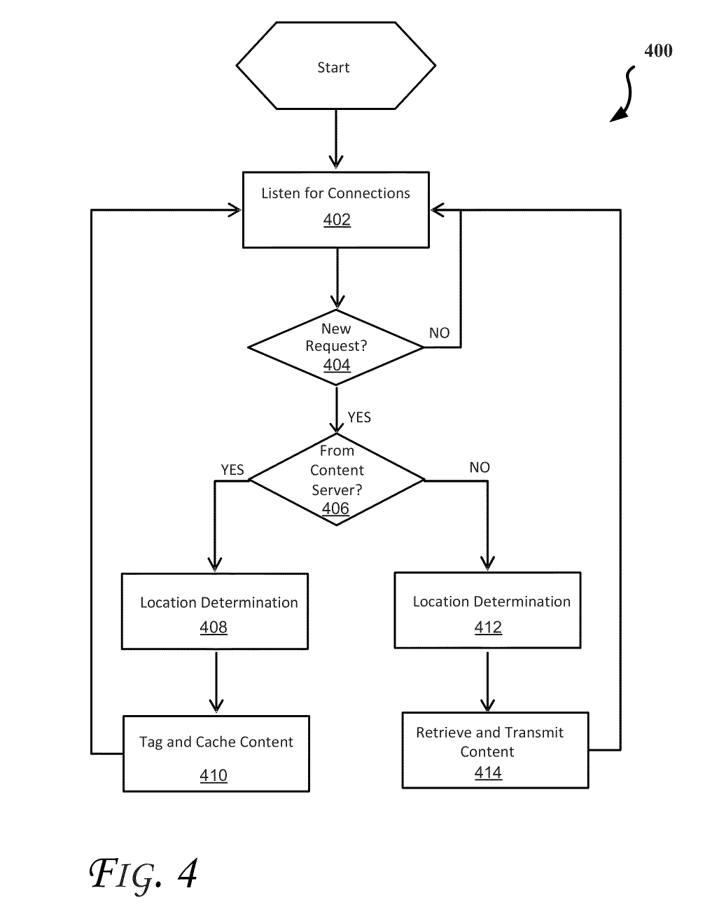

FIGS. 3-4 illustrate block diagrams of methods 300 and 400 that are performed at a smart device (e.g., device(s) 208) and a content delivery server (e.g., server(s) 206), respectively, according to some embodiments. In some embodiments, one or more components of FIGS. 2, 5, and/or 6 perform one or more operations of FIGS. 3-4. The operations of methods 300 and/or 400 may be continued as long as geographic content addressing in accordance with some embodiments is enabled or active.

In some embodiments, the following protocols are used to establish the outlined use cases and architecture discussed with reference to the previous figures. With respect to control, a register engine may be used to register a content engine with a registry server 204. The parameters for the registry, e.g., as provided by the content server 206, may include: (a) Claimed addresses/ranges for transmission; (b) Content properties: These can include resolution/frame-rate/coding parameters etc.; (c) Interactive Service: When true, this parameter indicates that a back channel is needed from the device to the content engine for user input for interactivity; and/or (d) Real time requirements.

Also, with respect to control, a protocol can be used to register a device with a registry server 204. The parameters for the device registry, e.g., provided by the device, may include: (a) Current address; (b) Capabilities: These can include processing power, execution environment, resolution/frame rate/coding parameters, etc. that are supported by the end device. Further, a previously registered content server 206 can update any of its registered properties through update engine.

Moreover, an update device control protocol may be used to update a previously registered end device, e.g., updating any of its registered properties through this protocol. In some cases, this protocol will be used to update the address currently associated with the device. Through a deregister engine, a previously registered engine can deregister using the control protocol. Also, through a deregister device control protocol, a previously registered end device can deregister using this protocol. Furthermore, in an embodiment, data channels are established using data protocol(s). Such protocol(s) may cover both the content and user input data transmission.

Referring to FIGS. 1-3, at an operation 302, location of a device (e.g., device 208) is determined. The location may be determined by the device (and in an embodiment verified by other information as discussed herein). At an operation 304, the device is communicatively coupled to the content server (e.g., server(s) 206). If there is content available at operation 306, at an operation 308, the device provides credentials (e.g., per registry with server(s) 204) and receives the content. Otherwise, if no content is available at operation 306 (or after operation 308), method 300 wait for a timer expiration at an operation 310 prior to detection of motion at an operation 312. The timer value may be set such that the device is not constantly transmitting or connecting to servers; hence, allowing for reduced power consumption. As shown in FIG. 3, after the timer expires, an operation 312 (e.g., the device or a motion detector in the vicinity of the device, which could be an external motion detector, for example) determines whether any motion has occurred. If there is no motion detected by the device, method 300 resumes with operation 304. By contrast if motion is detected at operation 312, method 300 resumes with operation 302.

Referring to FIGS. 1-4, at an operation 402, connection request(s) are detected. At an operation 404, if the detected connection request is new, it is determined whether the new connection request is from the content server (e.g., server(s) 202) at an operation 406. If the new request is from the content server 202, operation 408 determines the location of the target device for corresponding content and the content is then tagged and cached (by the entity 206 from entity 202) at an operation 410. Otherwise, if the request is not from the content server 202 (e.g., connecting entity is a device), then after the target device location determination at operation 412, the requisite content is retrieved and transmitted to the target device. Method 400 resumes with operation 402 after operations 410/414.

Accordingly, some embodiments propose new functionalities at content delivery engines, servers and mobile devices. New protocols are used to implement the proposed functionality. New mechanism and the use cases enable novel collaboration and information sharing usages. Various entities could be involved in delivering the hardware and software solutions that enable the creation and operation of infrastructure supporting such services. At least one embodiment utilizes one or more hardware components that deal with transmitting, facilitating, and consuming geographically addressed rich content. In one embodiment, end device (e.g., device(s) 208) need to agree to receiving location specific information, e.g., through installation of specific applications. Also, the content owners may need to explicitly join the centralized infrastructure for content delivery (e.g., via server(s) 206).

FIG. 5 illustrates a block diagram of an embodiment of a computing system 500. In various embodiments, one or more of the components of the system 500 may be provided in various electronic devices capable of performing one or more of the operations discussed herein with reference to some embodiments of the invention. For example, one or more of the components of the system 500 may be used to perform the operations discussed with reference to FIGS. 1-4, e.g., by processing instructions, executing subroutines, etc. in accordance with the operations discussed herein. Furthermore, system 500 may be used in laptops, mobile devices, ultrabooks, tablets, Smartphones, etc.

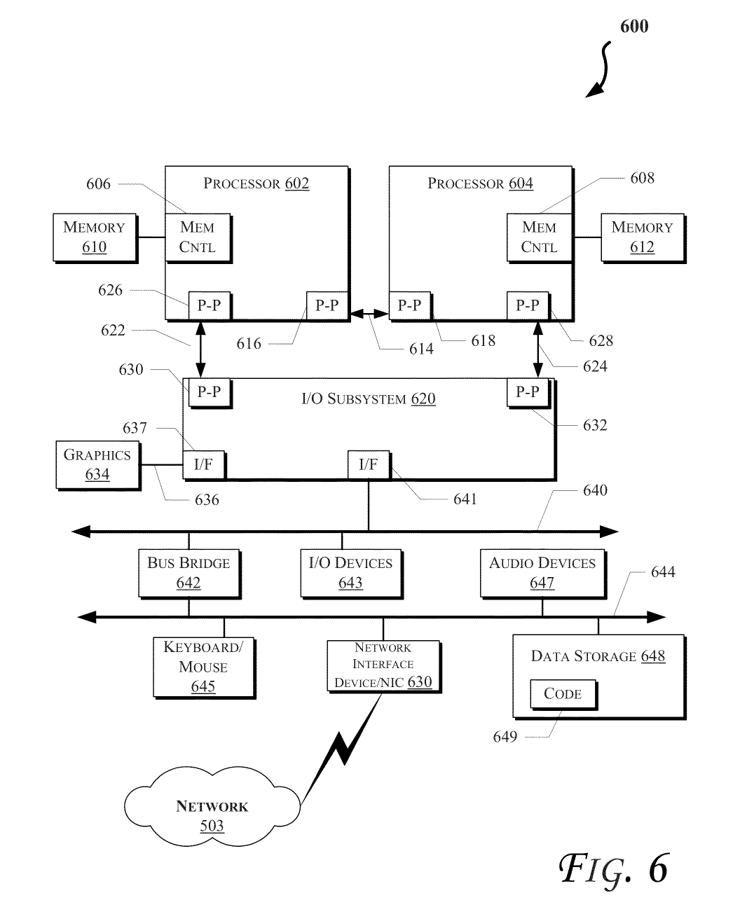

Also, various storage devices discussed herein (e.g., with reference to FIGS. 5 and/or 6) may be used to store data, operation results, etc. In one embodiment, data received over the network 503 (e.g., via network interface devices 530 and/or 630 and/or communicated between the various elements of FIGS. 1-4) may be stored in caches (e.g., L1 caches in an embodiment) present in processors 502 (and/or 602/604 of FIG. 6). These processor(s) may then perform the operations discussed herein to provide content to one or more target devices based on their location in accordance with various embodiments of the invention.

More particularly, the computing system 500 may include one or more central processing unit(s) (CPUs) 502 or processors that communicate via an interconnection network (or bus) 504. Hence, various operations discussed herein may be performed by a CPU in some embodiments. Moreover, the processors 502 may include a general purpose processor, a network processor (that processes data communicated over a computer network 503, or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500.

A chipset 506 may also communicate with the interconnection network 504. The chipset 506 may include a graphics and memory control hub (GMCH) 508. The GMCH 508 may include a memory controller 510 that communicates with a memory 512. The memory 512 may store data, including sequences of instructions that are executed by the CPU 502, or any other device included in the computing system 500. Furthermore, memory 512 may store one or more of the programs or algorithms discussed herein such as a compiler 513, instructions corresponding to executables, location data, etc. Same or at least a portion of this data (including instructions) may be stored in disk drive 528 and/or one or more caches within processors 502. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The GMCH 508 may also include a graphics interface 514 that communicates with a display 516. In one embodiment of the invention, the graphics interface 514 may communicate with the display 516 via an accelerated graphics port (AGP). In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the GMCH 508 and an input/output control hub (ICH) 520 to communicate. The ICH 520 may provide an interface to I/O (Input/Output) devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. Other devices may communicate via the bus 522. Also, various components (such as the network interface device 530) may communicate with the GMCH 508 in some embodiments of the invention. In addition, the processor 502, the GMCH 508, and/or the graphics interface 514 may be combined to form a single chip.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration such as discussed with reference to FIG. 6. For example, processors, memory, and/or input/output devices may be interconnected by a number of point-to-point interfaces.

More specifically, FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600. Furthermore, system 600 may be used in laptops, mobile devices, ultrabooks, tablets, Smartphones, etc.

As illustrated in FIG. 6, the system 600 may include several processors, of which only two, processors 602 and 604 are shown for clarity. The processors 602 and 604 may each include a local memory controller 606 and 608 to couple with memories 610 and 612. The memories 610 and/or 612 may store various data such as those discussed with reference to the memory 512 of FIG. 5.

The processors 602 and 604 may be any suitable processor such as those discussed with reference to the processors 602 of FIG. 6. The processors 602 and 604 may exchange data via a point-to-point (PtP) interface 614 using PtP interface circuits 616 and 618, respectively. The processors 602 and 604 may each exchange data with an I/O subsystem 620 via individual PtP interfaces 622 and 624 using point to point interface circuits 626, 628, 630, and 632. The I/O subsystem 620 may also exchange data with a high-performance graphics circuit 634 via a high-performance graphics interface 636, using a PtP interface circuit 637.

At least one embodiment of the invention may be provided by utilizing the processors 602 and 604. For example, the processors 602 and/or 604 may perform one or more of the operations of FIGS. 1-5. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The I/O subsystem 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse 645, the network interface device 630 discussed with reference to FIG. 6 (such as modems, network interface cards (NICs), or the like that may be coupled to the computer network 503), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a tangible (such as a non-transitory) machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

The following examples pertain to further embodiments. Example 1 includes an apparatus to provide geographic content addressing comprising: a server to transmit content to one or more devices at a first location based on location information corresponding to the first location of the one or more devices, wherein the location information corresponding to the first location of the one or more devices is to be registered prior to transmission of the content to the one or more devices at the first location. Example 2 includes the apparatus of example 1, wherein the content is to be modified in response to detection of motion by the one or more devices from the first location to a second location. Example 3 includes the apparatus of example 1, wherein the server is to transmit the content to the one or more devices at the first location in response to a determination that the one or more devices and the location information, corresponding to the first location, are registered at a registry server. Example 4 includes the apparatus of example 3, wherein the server is to comprise a content delivery server that is to register with the registry server prior to transmission of the content to the one or more devices at the first location. Example 5 includes the apparatus of example 1, wherein the server is to comprise a content delivery server that retrieves the content from a content server prior to transmission to the one or more devices. Example 6 includes the apparatus of example 5, wherein the content delivery server is to register with the registry server prior to transmission of the content to the one or more devices at the first location. Example 7 includes the apparatus of example 1, wherein the server is to comprise a content server that stores the content. Example 8 includes the apparatus of example 7, wherein the server is coupled to a registry server that is to register content for a given geographical region. Example 9 includes the apparatus of example 1, wherein at least one of the one or more devices is to comprise a display device. Example 10 includes the apparatus of example 1, wherein the location information is to comprise latitude, longitude, and elevation information. Example 11 includes the apparatus of example 1, wherein the location information is to comprise a direction of travel for the one or more devices.

Example 12 includes a method for providing geographic content addressing comprising: transmitting content from a server to one or more devices at a first location based on location information corresponding to the first location of the one or more devices, wherein the location information corresponding to the first location of the one or more devices is registered prior to transmission of the content to the one or more devices at the first location. Example 13 includes the method of example 12, further comprising modifying the content in response to detection of motion by the one or more devices from the first location to a second location. Example 14 includes the method of example 12, further comprising the server transmitting the content to the one or more devices at the first location in response to a determination that the one or more devices and the location information, corresponding to the first location, are registered at a registry server. Example 15 includes the method of example 14, wherein the server comprises a content delivery server that registers with the registry server prior to transmission of the content to the one or more devices at the first location. Example 16 includes the method of example 14, wherein the server comprises a content delivery server that retrieves the content from a content server prior to transmission to the one or more devices. Example 17 includes the method of example 16, further comprising the content delivery server registering with the registry server prior to transmission of the content to the one or more devices at the first location. Example 18 includes the method of example 12, further comprising the server storing the content. Example 19 includes the method of example 18, further comprising the server communicating with a registry server that registers content for a given geographical region. Example 20 includes the method of example 12, wherein the location information comprises latitude, longitude, and elevation information. Example 21 includes the method of example 12, wherein the location information is to comprise a direction of travel for the one or more devices.

Example 22 includes a computer-readable medium to provide geographic content addressing comprising one or more instructions that when executed on a processor configure the processor to perform one or more operations to: transmit content from a server to one or more devices at a first location based on location information corresponding to the first location of the one or more devices, wherein the location information corresponding to the first location of the one or more devices is registered prior to transmission of the content to the one or more devices at the first location. Example 23 includes the computer-readable medium of example 22, further comprising one or more instructions that when executed on the processor configure the processor to perform one or more operations to modify the content in response to detection of motion by the one or more devices from the first location to a second location. Example 24 includes the computer-readable medium of example 22, further comprising one or more instructions that when executed on the processor configure the processor to perform one or more operations to cause the server to transmit the content to the one or more devices at the first location in response to a determination that the one or more devices and the location information, corresponding to the first location, are registered at a registry server. Example 25 includes the computer-readable medium of example 22, further comprising one or more instructions that when executed on the processor configure the processor to perform one or more operations to cause the server to register with the registry server prior to transmission of the content to the one or more devices at the first location. Example 26 includes the computer-readable medium of example 22, further comprising one or more instructions that when executed on the processor configure the processor to perform one or more operations to cause the server to retrieve the content from a content server prior to transmission to the one or more devices. Example 27 includes the computer-readable medium of example 22, further comprising one or more instructions that when executed on the processor configure the processor to perform one or more operations to cause the content delivery server to register with the registry server prior to transmission of the content to the one or more devices at the first location. Example 28 includes the computer-readable medium of example 22, further comprising one or more instructions that when executed on the processor configure the processor to perform one or more operations to cause the server to store the content. Example 29 includes the computer-readable medium of example 22, further comprising one or more instructions that when executed on the processor configure the processor to perform one or more operations to cause the server to communicate with a registry server that registers content for a given geographical region. Example 30 includes the computer-readable medium of example 22, wherein the location information comprises latitude, longitude, and elevation information. Example 31 includes the computer-readable medium of example 22, wherein the location information is to comprise a direction of travel for the one or more devices.

Example 32 includes a system to provide geographic content addressing comprising: one or more devices at a first location, wherein at least one of the one or more devices is to comprise a display device; and a server to transmit content, to be displayed on the display device, based on location information corresponding to the first location of the one or more devices, wherein the location information corresponding to the first location of the one or more devices is to be registered prior to transmission of the content to the one or more devices at the first location. Example 33 includes the system of example 32, wherein the content is to be modified in response to detection of motion by the one or more devices from the first location to a second location. Example 34 includes the system of example 32, wherein the server is to transmit the content to the one or more devices at the first location in response to a determination that the one or more devices and the location information, corresponding to the first location, are registered at a registry server. Example 35 includes the system of example 34, wherein the server is to comprise a content delivery server that is to register with the registry server prior to transmission of the content to the one or more devices at the first location. Example 36 includes the system of example 32, wherein the server is to comprise a content delivery server that retrieves the content from a content server prior to transmission to the one or more devices. Example 37 includes the system of example 36, wherein the content delivery server is to register with the registry server prior to transmission of the content to the one or more devices at the first location. Example 38 includes the system of example 32, wherein the server is to comprise a content server that stores the content. Example 39 includes the system of example 38, wherein the server is coupled to a registry server that is to register content for a given geographical region. Example 40 includes the system of example 32, wherein the location information is to comprise latitude, longitude, and elevation information. Example 41 includes the system of example 32, wherein the location information is to comprise a direction of travel for the one or more devices.

Example 42 includes an apparatus to provide geographic content addressing comprising: means for a server to transmit content to one or more devices at a first location based on location information corresponding to the first location of the one or more devices; and means for the location information corresponding to the first location of the one or more devices to be registered prior to transmission of the content to the one or more devices at the first location. Example 43 includes the apparatus of example 42, further comprising means for modifying the content in response to detection of motion by the one or more devices from the first location to a second location. Example 44 includes the apparatus of example 42, further comprising means for the server to transmit the content to the one or more devices at the first location in response to a determination that the one or more devices and the location information, corresponding to the first location, are registered at a registry server. Example 45 includes the apparatus of example 44, further comprising means for the server to register with the registry server prior to transmission of the content to the one or more devices at the first location. Example 46 includes the apparatus of example 42, further comprising means for the server to retrieve the content from a content server prior to transmission to the one or more devices. Example 47 includes the apparatus of example 46, further comprising means for the content delivery server to register with the registry server prior to transmission of the content to the one or more devices at the first location. Example 48 includes the apparatus of example 42, further comprising means for the server store the content. Example 49 includes the apparatus of example 48, further comprising means for coupling the server to a registry server that registers content for a given geographical region. Example 50 includes the apparatus of example 42, further comprising means for displaying images at least one of the one or more devices. Example 51 includes the apparatus of example 42, wherein the location information is to comprise latitude, longitude, and elevation information. Example 52 includes the apparatus of example 42, wherein the location information is to comprise a direction of travel for the one or more devices.

Example 53 includes the apparatus of any of examples 1 to 9, wherein the location information is to comprise latitude, longitude, and elevation information.

Example 54 includes the apparatus of any of examples 1 to 9, wherein the location information is to comprise a direction of travel for the one or more devices.

Example 55 includes the apparatus of any of examples 1 to 8, wherein at least one of the one or more devices is to comprise a display device.

Example 56 includes a computer-readable medium to provide geographic content addressing comprising one or more instructions that when executed on a processor configure the processor to perform one or more operations of any of examples 12 to 21.

Example 57 includes an apparatus to provide geographic content addressing, the apparatus comprising means for performing one or more operations of any of examples 12 to 21.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1-25. (canceled)

26. An apparatus to provide geographic content addressing comprising:
a server to transmit content to one or more devices at a first location based on location information corresponding to the first location of the one or more devices,
wherein the location information corresponding to the first location of the one or more devices is to be registered prior to transmission of the content to the one or more devices at the first location.

27. The apparatus of claim 26, wherein the content is to be modified in response to detection of motion by the one or more devices from the first location to a second location.

28. The apparatus of claim 26, wherein the server is to transmit the content to the one or more devices at the first location in response to a determination that the one or more devices and the location information, corresponding to the first location, are registered at a registry server.

29. The apparatus of claim 28, wherein the server is to comprise a content delivery server that is to register with the registry server prior to transmission of the content to the one or more devices at the first location.

30. The apparatus of claim 26, wherein the server is to comprise a content delivery server that retrieves the content from a content server prior to transmission to the one or more devices.

31. The apparatus of claim 30, wherein the content delivery server is to register with the registry server prior to transmission of the content to the one or more devices at the first location.

32. The apparatus of claim 26, wherein the server is to comprise a content server that stores the content.

33. The apparatus of claim 32, wherein the server is coupled to a registry server that is to register content for a given geographical region.

34. The apparatus of claim 26, wherein at least one of the one or more devices is to comprise a display device.

35. The apparatus of claim 26, wherein the location information is to comprise latitude, longitude, and elevation information.

36. The apparatus of claim 26, wherein the location information is to comprise a direction of travel for the one or more devices.

37. A method for providing geographic content addressing comprising:
transmitting content from a server to one or more devices at a first location based on location information corresponding to the first location of the one or more devices,
wherein the location information corresponding to the first location of the one or more devices is registered prior to transmission of the content to the one or more devices at the first location.

38. The method of claim 37, further comprising modifying the content in response to detection of motion by the one or more devices from the first location to a second location.

39. The method of claim 37, further comprising the server transmitting the content to the one or more devices at the first location in response to a determination that the one or more devices and the location information, corresponding to the first location, are registered at a registry server.

40. The method of claim 39, wherein the server comprises a content delivery server that registers with the registry server prior to transmission of the content to the one or more devices at the first location.

41. The method of claim 39, wherein the server comprises a content delivery server that retrieves the content from a content server prior to transmission to the one or more devices.

42. The method of claim 41, further comprising the content delivery server registering with the registry server prior to transmission of the content to the one or more devices at the first location.

43. The method of claim 37, further comprising the server storing the content.

44. The method of claim 43, further comprising the server communicating with a registry server that registers content for a given geographical region.

45. The method of claim 37, wherein the location information comprises latitude, longitude, and elevation information.

46. The method of claim 37, wherein the location information is to comprise a direction of travel for the one or more devices.

47. A non-transitory computer-readable medium to provide geographic content addressing comprising one or more instructions that when executed on a processor configure the processor to perform one or more operations to:
transmit content from a server to one or more devices at a first location based on location information corresponding to the first location of the one or more devices,
wherein the location information corresponding to the first location of the one or more devices is registered prior to transmission of the content to the one or more devices at the first location.

48. The computer-readable medium of claim 47, wherein the one or more operations are to comprise modifying the content in response to detection of motion by the one or more devices from the first location to a second location.

49. The computer-readable medium of claim 47, wherein the one or more operations are to comprise the server transmitting the content to the one or more devices at the first location in response to a determination that the one or more devices and the location information, corresponding to the first location, are registered at a registry server.

50. A system to provide geographic content addressing comprising:
one or more devices at a first location, wherein at least one of the one or more devices is to comprise a display device; and
a server to transmit content, to be displayed on the display device, based on location information corresponding to the first location of the one or more devices,
wherein the location information corresponding to the first location of the one or more devices is to be registered prior to transmission of the content to the one or more devices at the first location.

51. The system of claim 50, wherein the content is to be modified in response to detection of motion by the one or more devices from the first location to a second location.

52. The system of claim 50, wherein the location information is to comprise latitude, longitude, and elevation information.
